(19) United States
(12) Patent Application Publication
(10) Pub. No.: US 2012/0032623 A1
(43) Pub. Date: Feb. 9, 2012

(54) METHOD OF CONTROLLING FAN SPEED

(75) Inventor: Chih-Chang Tsai, Taoyuan County (TW)

(73) Assignees: 3Y POWER TECHNOLOGY (TAIWAN), INC., Taoyuan County (TW); FSP TECHNOLOGY INC., Taoyuan County (TW)

(21) Appl. No.: 13/179,575

(22) Filed: Jul. 11, 2011

(30) Foreign Application Priority Data
Aug. 3, 2010 (TW) 99125759

(51) Int. Cl. H02P 1/04

(52) U.S. Cl. 318/461

(57) ABSTRACT

A method of controlling fan speed is provided. The method includes: setting a target speed of the fan; providing an actual control speed signal and using the actual control speed signal to drive the fan so as to obtain an actual speed of the fan; determining whether the actual speed of the fan is equal to the set target speed; and when the actual speed of the fan is equal to the set target speed, continuously using the provided actual control speed signal to drive the fan, otherwise, gradually compensating the intensity of the provided actual control speed signal until the actual speed of the fan is equal to the set target speed after the fan is driven by the gradually compensated actual control speed signal.

### CROSS-REFERENCE TO RELATED APPLICATION

This application claims the priority benefit of Taiwan application serial no. 99125759, filed on Aug. 3, 2010. The entirety of the above-mentioned patent application is hereby incorporated by reference herein and made a part of this specification.

### BACKGROUND OF THE INVENTION

1. Field of the Invention

The invention relates to a method of controlling speed, and more particularly, to a method capable of controlling fan speed precisely.

2. Description of Related Art

It is known that internal components (e.g. CPU) and/or apparatuses (e.g. power supply) of conventional computer devices are installed with heat dissipation devices (e.g. heat dissipating sheet, fan, and the like). Among these heat dissipation devices, fans are one of the most essential and important components for their capability of dissipating heat generated by internal components and/or apparatuses in computer devices out of casings of computer devices, so that computer device systems can operate normally.

In general, control speed signals used to drive fans can be categorized into direct current (DC) voltage or pulse width modulation signal (PWM signal). The speed of a fan (in units of revolutions per minute/RPM) can be controlled by changing the value of DC voltage or changing the duty cycle of PWM signal.

However, identical control speed signals usually lead to the deviation of fan speed (possible deviation of hundreds or even thousands of revolutions) due to different fan specifications and/or deterioration of fans. Consequently, fans with large speed deviations may not be capable of effectively dissipating heat out of casings of computer devices, such that computer device systems can not operate normally. Furthermore, crashes of computer device systems or hardware damages leading to unrecoverable computer device systems may also result.

### SUMMARY OF THE INVENTION

Accordingly, the invention is directed to a method of controlling fan speed. The method is capable of controlling the speed of a fan precisely so as to resolve the issue above.

A method of controlling a fan speed in the invention includes: setting a target speed of a fan; providing an actual control speed signal and using the actual control speed signal to drive the fan so as to obtain an actual speed of the fan; determining whether the actual speed of the fan is equal to the set target speed; and when the actual speed of the fan is equal to the set target speed, continuously using the provided actual control speed signal to drive the fan, otherwise, gradually compensating an intensity of the provided actual control speed signal until the actual speed of the fan is equal to the set target speed after the fan is driven by the gradually compensated actual control speed signal.

In light of the foregoing, the method of controlling fan speed in the invention mainly adjusts the actual speed of the fan to equal the set target speed through a feedback compensation mechanism. Thus, the problem of identical control speed signals with fan speed deviation caused by different fan specifications and/or deterioration of fans can be improved effectively.

It should be understood that the descriptions aforementioned and the following embodiments are merely exemplary and illustrative, and the scope of the invention is not limited thereto.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A illustrates a flow chart of a method of controlling a fan speed according to an embodiment of the invention.

FIG. 1B is a detailed illustration of several steps in FIG. 1A.

### DESCRIPTION OF EMBODIMENTS

Embodiments of the invention are described in details below, and examples of the embodiments are illustrated in the drawings. Moreover, identical devices/components/steps in the drawings and embodiments are denoted with identical notations to represented identical or similar parts whenever possible.

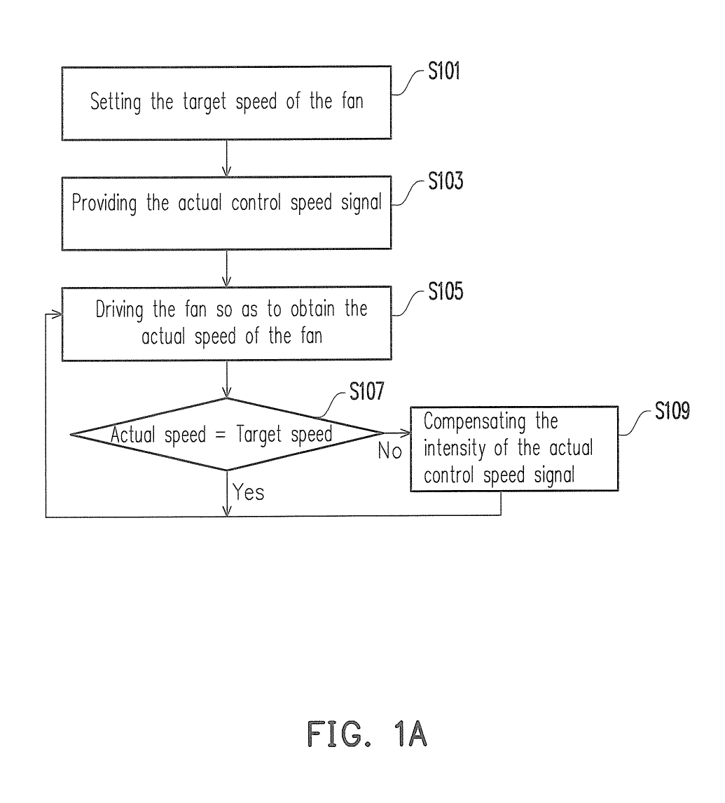

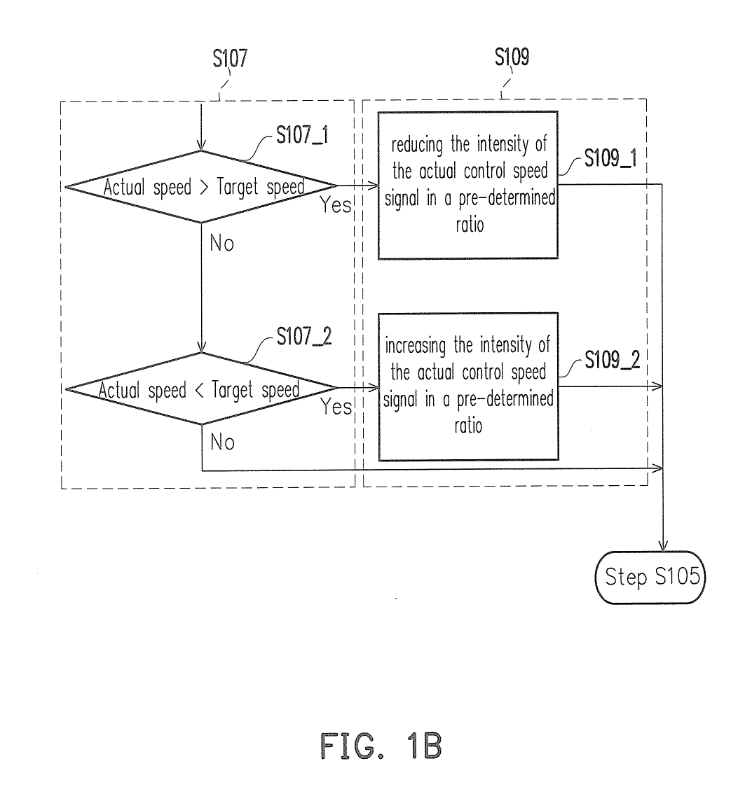

FIG. 1A illustrates a flow chart of a method of controlling a fan speed according to an embodiment of the invention. Referring to FIG. 1A, the method includes the following. Firstly, a target speed of a fan is set (step S101). Next, an actual control speed signal is provided (step S103). The actual control speed signal is used to drive the fan so as to obtain an actual speed of the fan (step S105). Thereafter, whether the actual speed of the fan is equal to the target speed set in step S101 is determined (step S107). Finally, when the actual speed of the fan is equal to the target speed set in step S101 (that is, “yes” for step S107), the fan is driven by using the actual control speed signal provided in step S103 continuously; otherwise, (that is, “no” for step S107) an intensity of the actual control speed signal provided in step S103 is compensated gradually (step S109) until the actual speed of the fan is equal to the set target speed after the fan is driven by the gradually compensated actual control speed signal.

More specifically, FIG. 1B is a detailed illustration of step S107 and step S109 in FIG. 1A. Referring to FIGS. 1A and 1B, in the present embodiment, the determining of whether the actual speed of the fan is equal to the target speed set in step S101 may include determining whether the actual speed of the fan is faster than the target speed set in step S101 (step S107_1); and determining whether the actual speed of the fan is slower than the target speed set in step S101 (step S107_2).

Thus, when the actual speed of the fan is not faster nor slower than the target speed set in step S101 (that is, “no” for steps S107_1 and S107_2), the actual speed of the fan after the fan is driven by the actual control speed signal provided in step S103 is determined to be equal to the target speed set in step S101. Accordingly, the actual control speed signal provided in step S103 is used continuously to drive the fan, such that the actual speed of the fan is equal to the target speed set in step S101. In other words, the intensity of the actual control speed signal provided in step S103 is sufficient for controlling the actual speed of the fan to equal to the target speed set in step S101.

In addition, when the actual speed is faster than the target speed set in step S101 (that is, “yes” for step S107_1), the actual speed of the fan is determined not equal to the target speed set in step S101 (that is, “no” for step S107). In other words, the intensity of the actual control speed signal provided in step S103 is sufficient for controlling the actual speed of the fan to be faster than the target speed set in step S101. As a result, the compensating of the intensity of the actual control speed signal illustrated in step S109 includes gradually reducing the intensity of the actual control speed signal provided in step S103 in a pre-determined ratio (step S109_1) until the actual speed of the fan is equal to the target speed set in step S101 after the fan is driven by the gradually reduced actual control speed signal.

Further, when the actual speed of the fan is slower than the target speed set in step S101 (that is, “yes” for step S107_2), the actual speed of the fan is determined not equal to the target speed set in step S101 (that is, “no” for step S107). In other words, the intensity of the actual control speed signal provided in step S103 is sufficient for controlling the actual speed of the fan to be slower than the target speed set in step S101. As a result, the compensating of the intensity of the actual control speed signal illustrated in step S109 further includes gradually increasing the intensity of the actual control speed signal provided in step S103 in a pre-determined ratio (step S109_2) until the actual speed of the fan is equal to the target speed set in step S101 after the fan is driven by the gradually increased actual control speed signal.

It should be noted that since the actual control speed signal configured to drive the fan is usually a direct current (DC) voltage or a pulse width modulation signal (PWM) signal, the method of gradually reducing/increasing the intensity of the actual control speed signal provided in step S103 with a pre-determined ratio as illustrated in steps S109_1 and S109_2 may adopt 0.5V (when the actual control speed signal is a DC voltage, but not limited thereto) or 5% (when the actual control speed signal is a PWM signal, but not limited thereto) as the pre-determined ratio to gradually reduce/increase the intensity of the actual control speed signal provided in step S103.

For example, the target speed set in step S101 is 5000 revolutions per minute (that is, 5000 RPM) and the actual speed of the fan is 4000 revolutions per minute (that is, 4000 RPM) after the fan is driven by the actual control speed signal provided by step S103. As the actual speed of the fan after the fan is driven by the actual control speed signal provided by step S103 is determined to be slower than the target speed set in step S101 in step S107 (4000 RPM<5000 RPM), steps S105-S109 are repeated for using 0.5V (when the actual control speed signal is a DC voltage, but not limited thereto) or 5% (when the actual control speed signal is a PWM signal, but not limited thereto) as the pre-determined ratio to gradually increase the intensity of the actual control speed signal provided in step S103 (i.e. the original DC voltage 4V is increased 0.5V at a time to 5V, or the original duty cycle 40% is increased 5% at a time to 50%, but the invention is not limited thereto) until the actual speed of the fan is equal to the target speed set in step S101 after the fan is driven by the gradually increased actual control speed signal.

Similarly, in another example, the target speed set in step S101 is 5000 revolutions per minute (that is, 5000 RPM) and the actual speed of the fan is 6000 revolutions per minute (that is, 6000 RPM) after the fan is driven by the actual control speed signal provided by step S103. As the actual speed of the fan after the fan is driven by the actual control speed signal provided by step S103 is determined to be faster than the target speed set in step S101 in step S107 (6000 RPM>5000 RPM), steps S105-S109 are repeated for using 0.5V (when the actual control speed signal is a DC voltage, but not limited thereto) or 5% (when the actual control speed signal is a PWM signal, but not limited thereto) as the pre-determined ratio to gradually reduce the intensity of the actual control speed signal provided in step S103 (i.e. the original DC voltage 6V is reduced 0.5V at a time to 5V, or the original duty cycle 60% is reduced 5% at a time to 50%, but the invention is not limited thereto) until the actual speed of the fan is equal to the target speed set in step S101 after the fan is driven by the gradually reduced actual control speed signal.

It should be noted that the method of controlling the fan speed in the invention mainly adjusts the actual speed of the fan to equal the set target speed through a feedback compensation mechanism (that is, repeating steps S105-S109). Therefore, the problem of identical control speed signals with fan speed deviation caused by different fan specifications and/or deterioration of fans can be improved effectively.

On the other hand, in practical application, the method of controlling the fan speed in the invention is at least applied in computer device systems. Accordingly, identical control speed signals do not cause deviations of fan speed due to different fan specifications and/or fan deterioration. Consequently, the fan can effectively dissipate the heat generated by internal components (i.e. CPU) and or devices (i.e. power supply) in computer devices out of casings of computer devices, so that computer device systems can operate normally. Furthermore, crashes of computer device systems or unrecoverable hardware damages are prevented. Obviously, the method of controlling fan speed in the invention is applicable to any electronic device system adopting fans. Thus, the embodiments illustrated above do not limit the application scope of the invention.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of controlling a fan speed, the method comprising:
setting a target speed of a fan;
providing an actual control speed signal and using the actual control speed signal to drive the fan so as to obtain an actual speed of the fan;
determining whether the actual speed of the fan is equal to the set target speed; and
when the actual speed of the fan is equal to the set target speed, continuously using the actual control speed signal to drive the fan, otherwise, gradually compensating an intensity of the actual control speed signal until the actual speed of the fan is equal to the set target speed after the fan is driven by the gradually compensated actual control speed signal.

2. The method of controlling the fan speed as claimed in claim 1, wherein the determining of whether the actual speed of the fan is equal to the target speed set comprises:
determining whether the actual speed of the fan is faster than the set target speed; and
determining whether the actual speed of the fan is slower than the set target speed.

3. The method of controlling the fan speed as claimed in claim 2, wherein when the actual speed of the fan is not faster than the set target speed and the actual speed of the fan is not slower than the set target speed, the actual speed is determined to be equal to the set target speed and the fan is driven by using the actual control speed signal continuously.

4. The method of controlling the fan speed as claimed in claim 2, wherein when the actual speed is faster than the set target speed, the actual speed is determined to be not equal to the set target speed, and the compensating of the intensity of the actual control speed signal comprises:
gradually reducing the intensity of the actual control speed signal in a pre-determined ratio until the actual speed of the fan is equal to the set target speed after the fan is driven by the gradually reduced actual control speed signal.

5. The method of controlling the fan speed as claimed in claim 2, wherein when the actual speed is slower than the set target speed, the actual speed is determined to be not equal to the set target speed, and the compensating of the intensity of the actual control speed signal comprises:
gradually increasing the intensity of the actual control speed signal in a pre-determined ratio until the actual speed of the fan is equal to the set target speed after the fan is driven by the gradually increased actual control speed signal.

6. The method of controlling the fan speed as claimed in claim 1, wherein the actual control speed signal comprises a direct current voltage or a pulse width modulation signal.
